(19) United States
(12) Patent Application Publication
(10) Pub. No.: US 2013/0158774 A1
(43) Pub. Date: Jun. 20, 2013

(54) PARKING CONTROL DEVICE

(71) Applicant: GM Global Technology Operations LLC, Detroit, MI (US)

(72) Inventors: Christoph Schmidt, Wiesbaden (DE); Stefan Bauer, Wiesbaden (DE)

(73) Assignee: GM GLOBAL TECHNOLOGY OPERATIONS LLC, Detroit, MI (US)

(21) Appl. No.: 13/723,016

(22) Filed: Dec. 20, 2012

(30) Foreign Application Priority Data
Dec. 20, 2011 (DE) 102011121722.7

(51) Int. Cl. B62D 15/02

(52) U.S. Cl. CPC B62D 15/0285
USPC 701/25

(57) ABSTRACT

A device for the controlled parking of a motor vehicle on the basis of a stored path trajectory is provided. The device includes at least one road marking sensor for detecting road markings on the roadway of the path trajectory. The device records the position of the road markings relative to the path trajectory and when retracing the path trajectory finds the recorded road markings by means of the road marking sensor and corrects the driving path as necessary on this basis. This results in more accurately controlled parking during the parking operation.

### CROSS-REFERENCE TO RELATED APPLICATION

This application claims priority to German Patent Application No. 10 2011 121 722.7, filed Dec. 20, 2011, which is incorporated herein by reference in its entirety.

### TECHNICAL FIELD

The technical field relates to a device for the controlled parking of a vehicle on the basis of a stored path trajectory.

### BACKGROUND

Parking control devices are known which are used to either support a driver when approaching a parking space or a parking spot, or to accomplish this in automated fashion without involving a driver. To this end the distances to lateral obstructions are ascertained by distance sensors with the vehicle steering/vehicle drive system being controlled accordingly. Further there are devices for the controlled parking into regularly used parking spaces, in which path trajectories are recorded, preferably several times over, during entry into the parking space, with the motor vehicle being automatically moved later along a path trajectory ascertained therefrom.

The disadvantage is that in many cases laterally fixed orientation points are missing along the path trajectory which can be detected by means of the environmental sensors and used for fixing the path trajectory, in order to ascertain for example as to whether the vehicle is offset in relation to the optimal path so that any further movement into the parking space making it very difficult (due to considerable steering movements) or even impossible to move any further into the parking lot. In addition, other objects, desirable features and characteristics will become apparent from the subsequent summary and detailed description, and the appended claims, taken in conjunction with the accompanying drawings and this background.

### SUMMARY

Accordingly, the present disclosure avoids the above disadvantages and proposes a device for the controlled parking of a vehicle and a method for its operation which avoids the above disadvantages and permits improved parking control.

According to various exemplary aspects of the present disclosure this requirement is met by a device, which comprises at least one road marking sensor for detecting road markings on the roadway of the path trajectory, wherein the device records the position of the road markings relative to the path trajectory and when the path trajectory is retraced finds the recorded road markings by means of the road marking sensors, and on this basis, corrects the driving path, if necessary. By using the device of the present disclosure it is possible, either by detecting markings present on the roadway such as center strips or side strips or roadway arrows or after manually applying road markings, to achieve a more accurate vehicle control during the parking operation.

According to another exemplary embodiment of the present disclosure, several road marking sensors are provided on the motor vehicle which generally detect the area directly in front and laterally in front of the motor vehicle. Also sensors provided for other reasons which are provided for road profile examinations or for tracking may be used for the purpose according to the present disclosure, wherein the signals thereof are examined for the presence of markings.

According to another exemplary embodiment of the present disclosure, the at least one road marking sensor is infrared-sensitive. In conjunction with road markings applied to the roadway using an infrared fluorescent substance, an improved vehicle guidance can be achieved without the road markings being visible to humans. This means that such substantially invisible road markings are not disturbing to the general public.

According to another exemplary embodiment of this design, the device comprises at least one IR or UV light source for illuminating the area of the roadway detected by the road marking sensor. In this way infrared or ultraviolet fluorescent road markings can be detected and evaluated. For example when using UV light, white road markings appear very bright which allows them to be detected by means of the road marking sensors.

According to another exemplary embodiment of the present disclosure the at least one road marking sensor is a metal sensor. This design is of advantage if metallic components are present on or near the driven-over section such as so-called rounded arched marking nails or, in one example, in garages, fixings for garage doors or metallic strips on ledges. Also in the case of underground car parks with metallic lifting devices the transition onto the lifting device can be ascertained and thus accurate positioning can be achieved in driving direction.

According to another exemplary embodiment the at least one road marking sensor is an inductive or capacitive sensor. An inductive sensor generates a magnetic AC field which is modified by steel plate. A capacitive sensor generates an electrical field which is also modified by steel plate. Or both sensor types, i.e. inductive and capacitive sensors, may be used in combination.

According to another exemplary embodiment of the present disclosure several road marking sensors are provided of which at least one is an optical sensor and at least one is a metal sensor. In this way several types of road markings can be detected permitting an even more accurately controlled entry into the parking space.

According to another exemplary embodiment of the present disclosure a method for the controlled parking of a motor vehicle using the above-described device is proposed, wherein by means of at least one road marking sensor road markings are detected on the roadway of the path trajectory and recorded relative to the path trajectory, and wherein, when retracing the path trajectory, the recorded road markings are found by means of the road marking sensor and the driving path is corrected as necessary on this basis.

In one example, markings are placed on the roadway in the area of the path trajectory to be retraced which markings are detected by means of the road marking sensor. Where the area in front of the parking space is the property of the driver road markings such as small dots can be applied without problems. In the case of hired objects, public areas or areas owned jointly with others such as in an underground car park, the application of “private markings” is usually problematic or not permitted. In such cases the road markings may be applied with a substance which contains an infrared fluorescent material. Such road markings are almost or totally invisible to the human eye and therefore have no substantially detrimental effect upon third parties.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a motor vehicle with sensors and road markings.

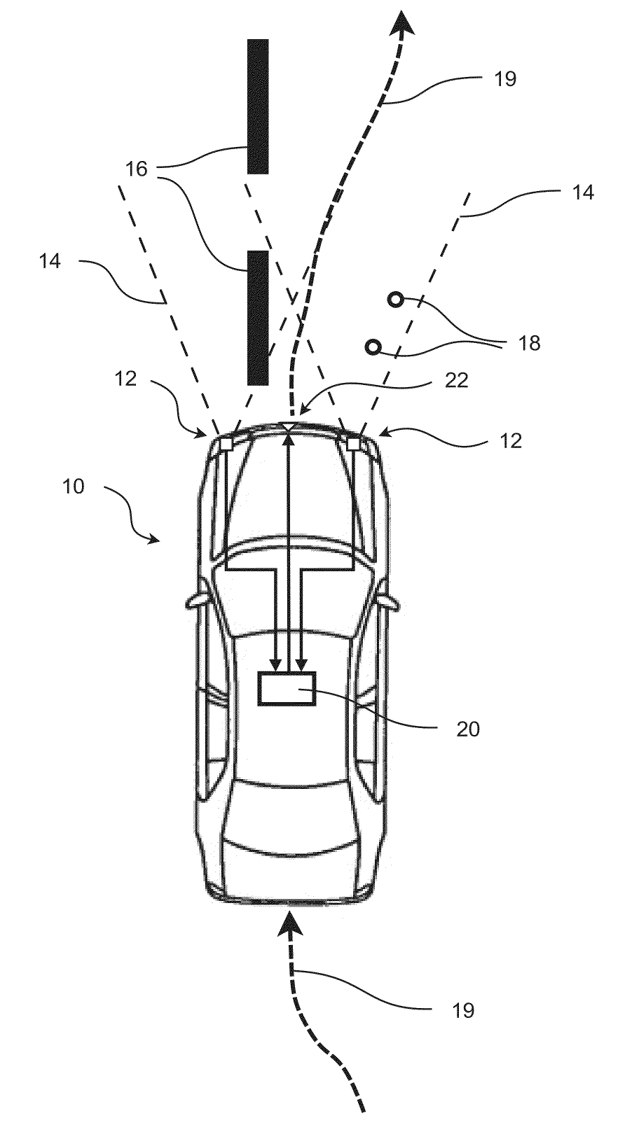

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

The motor vehicle 10 comprises several road marking sensors 12 on its front with respectively one detection zone 14 shown as a broken line, within which zone the roadway in front of the motor vehicle 10 is examined for the presence of road markings 16, 18. The vehicle autonomously follows a path trajectory 19 which leads to a parking space not shown.

The road marking sensors 12 are connected with a control device 20 which reads the signals of the sensors 12 and which checks, depending upon the type of sensor, whether road markings 16, 18 are present in front of motor vehicle 10. The control device 20 in one example also contains the data of path trajectory 19 on the basis of which the motor vehicle 10 is controlled autonomously.

The sensors 12 may be designed as optical and/or capacitive and/or inductive sensors. The control device 20 is also connected with a roadway illumination facility 22 which in one example irradiates the roadway area detected by the road marking sensors 12 by means of ultraviolet light.

In case road markings 16, 18 are present in front of the motor vehicle 10 and are detected by sensors 12, the control device 20 ascertains their positions by way of the signals of sensors 12 in respect of the vehicle-internal coordinate system and the stored path trajectory 19 and stores them. If the road markings 16 are square-shaped corner points may generally be stored, if they are circular and cover only a small area, the center points may be stored.

Insofar as ferromagnetic-metallic marking nails 18 are present within the area of coverage of the capacitive and/or inductive sensors 12 their approximate positions are determined and stored in the same way.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A device for the controlled parking of a motor vehicle on the basis of a stored path trajectory, comprising:
at least one road marking sensor for detecting road markings on the roadway of the path trajectory,
wherein the device records the position of the road markings relative to the path trajectory and when retracing the path trajectory finds the recorded road markings and on this basis corrects the driving path, as necessary.

2. The device according to claim 1, wherein several road marking sensors are provided on the motor vehicle.

3. The device according to claim 1, wherein the at least one road marking sensor is infrared (IR) light sensitive or ultraviolet (UV) light sensitive.

4. The device according to claim 3, further comprising at least one IR light source and UV light source for illuminating the roadway area detected by the at least one road marking sensor.

5. The device according to claim 1, wherein the at least one road marking sensor is a metal sensor.

6. The device according to claim 1, wherein the at least one road marking sensor is an inductive sensor or capacitive sensor.

7. The device according to claim 1, wherein the at least one road marking sensor further comprises several road marking sensors of which at least one is an optical sensor and at least one is a metal sensor.

8. A method for the controlled parking of a motor vehicle, comprising:
detecting by means of at least one road marking sensor road markings on a roadway of a path trajectory;
recording the road markings relative to the path trajectory; and
when retracing the path trajectory, the recorded road markings are found and the driving path is corrected as necessary on this basis.

9. The method according to claim 8, wherein markings are applied on the roadway in the area of the path trajectory to be traced, which are detected by means of the at least one road marking sensor.

10. The method according to claim 8, wherein a substance with an infrared fluorescent material is used for the road markings.

11. A motor vehicle, comprising:
at least one road marking sensor for detecting road markings on the roadway of the path trajectory coupled to the motor vehicle; and
a device for the controlled parking of the motor vehicle on the basis of a stored path trajectory that records the position of the road markings relative to the path trajectory with the at least one road marking sensor and when retracing the path trajectory finds the recorded road markings and on this basis corrects the driving path, as necessary.

12. The motor vehicle according to claim 11, wherein the at least one road marking sensor is infrared (IR) light sensitive or ultraviolet (UV) light sensitive.

13. The motor vehicle according to claim 12, further comprising at least one IR light source and UV light source for illuminating the roadway area detected by the at least one road marking sensor.

14. The motor vehicle according to claim 11, wherein the at least one road marking sensor is a metal sensor.

15. The motor vehicle according to claim 11, wherein the at least one road marking sensor is an inductive sensor or capacitive sensor.

16. The motor vehicle according to claim 11, wherein the at least one road marking sensor further comprises several road marking sensors of which at least one is an optical sensor and at least one is a metal sensor.
